(19) United States
(12) Patent Application Publication
(10) Pub. No.: US 2006/0280326 A1
(43) Pub. Date: Dec. 14, 2006

(54) ROTATABLE SUB WOOFER SPEAKER SYSTEM

(75) Inventors: Warren R. Stevens, Olathe, KS (US); Joseph M. Vojtko, Lawrence, KS (US); David Allen, Lawrence, KS (US)

Correspondence Address: BLACKWELL SANDERS PEPER MARTIN LLP, 4801 Main Street, Suite 1000, KANSAS CITY, MO, 64112, US

(73) Assignee: MARTIN-LOGAN, LTD., Lawrence, KS (US)

(21) Appl. No.: 11/160,181

(22) Filed: Jun. 13, 2005

(51) Int. Cl. H04R 1/02

(52) U.S. Cl. 381/386

(57) ABSTRACT

The combination of a stand and speaker enclosure having a plurality of walls, a driveable speaker located on one of the walls, connectors for interfacing to the speaker located on another wall and wherein the stand and the enclosure are cooperatively configured to facilitate the orientation of the speaker between a forward firing position and a down firing position and wherein the driveable speaker is elevated in the down firing position to optimize sound emanation.

### CROSS-REFERENCE TO RELATED APPLICATIONS

Not Applicable.

### BACKGROUND OF THE INVENTION

The present invention relates to speaker systems. More specifically, the present invention is directed to small-volume woofers or subwoofers that produce high-fidelity, low-frequency acoustic energy using one or more drivers. Traditionally, such devices have been provided front/forwarding firing systems or down-firing systems.

Today, stereo systems, audio/visual equipment and computers to name a few electronic devices, are an integral part of every home or office. In conjunction with this myriad of devices there are numerous shapes, sizes, forms and variations of speaker systems that are utilized by such devices to provide acoustical energy or sound to a listener. These speaker systems address both functional and aesthetic needs within the environment that they are placed. Directional sound, room acoustics, surround sound effects and other such attributes, which are essential to enhancing listener experience, are key elements in the design of speaker systems. In order to provide less physically intrusive speakers in the environment into which speakers are placed, issues of appearance or methods of blending the speaker into the environment are also taken into account by manufacturers and designers of such systems. In some instances, the speaker is camouflaged to blend in with the environment. In other instances the speakers are scaled down in size to be less noticeable. Irrespective of the physical characteristics, such speakers must ultimately be installed or placed somewhere within a room, a confined area, or some other environment, or in some cases the speakers are built into a cabinet or other enclosure. These speakers are manufactured and designed primarily to provide a pleasant end user audible experience. To accomplish this task, there are several types of speaker systems, each of which span a range of output frequencies and tones and are designed for strategic placement within a listening environment.

In home audio and home theatre applications in particular, a high resolution speaker system for providing low frequency acoustic energy, known as a sub woofer, is one of the generally utilized speakers. Traditional sub woofers are designed and installed in one of two configurations namely, down firing or front firing. An end customer must decide on one of the directional firing options of a speaker at the time of purchase and live with that choice. When a room is redesigned or the speaker is moved to a new environment, that earlier choice may no longer be appropriate either for acoustical reasons or for aesthetic reasons. Regardless, the end customer is locked into the configuration that was initially purchased with the only other option being the purchase of a second system that has the alternate configuration. There are several reasons for this, for example, if a listener were to physically orient a front firing sub woofer into a down firing position, the sounds would be muffled and the acoustic characteristics of the speaker will be greatly distorted. Conversely, orienting a down firing sub woofer in a front firing position would not be as aesthetically pleasing because areas of the speaker enclosure that were not intended to be visible may be exposed.

There is therefore a need for a system that provides versatility to an end user, allowing the end user to place a subwoofer in varying locations in a room, choose between front firing or down firing configuration and present a more aesthetically pleasing piece of equipment that can look good or blend in with other furnishings. Even further there is a need for a system that allows the end user a variety of installation options.

The present invention addresses this need and overcomes the limitations of the prior art.

### SUMMARY OF THE INVENTION

To address these and other concerns, the present invention provides, among other things, a sub-woofer speaker apparatus, comprising a speaker enclosure having a driveable speaker located on a first side of the speaker enclosure, with the first side having one or more grommets recessed therein. A plurality of electrical connectors provide an interface to the speaker apparatus and are located on a second side of the speaker enclosure. This connector wall of the speaker apparatus also has one or more grommets recessed therein. A stand with an opening sized to enable reverberation in a down firing configuration, has one or more bosses to engage the grommets on either of the first or seconds sides of the speaker enclosure. The stand is removedly attachable to either side of the speaker enclosure for orienting the speaker apparatus between a front firing position and a down firing position.

The present invention further provides a driveable speaker located on a first side of the speaker enclosure and a plurality of connectors located on a second side of the speaker enclosure, wherein the two sides are perpendicular to each other. Even further, in the present invention the speaker enclosure is rotatable approximately 90 degrees between the front firing position and the down firing position.

Further still, the present invention includes a stand to elevate the sub-woofer speaker from the floor level. The height of the speaker's elevation is computed as a function of the characteristic of the driveable speaker system, including the speaker's dimension.

Further yet, the present invention provides a speaker enclosure that is a cube and which utilizes a stand having a perimeter that matches the perimeter of the cubed speaker enclosure.

Other features and advantages of the invention will become apparent to those skilled in the art upon review of the following detailed description and drawings.

### BRIEF DESCRIPTION OF THE DRAWINGS

The present invention is further described with reference to the accompanying drawings, which show various constructions and implementations of the present invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the present invention.

FIG. 1 is an exploded view of an exemplary speaker system and components of an embodiment of the present invention;

FIG. 2 is a perspective view of a speaker system in a front firing configuration of the present invention;

FIG. 3 is a partially exploded side view of the speaker system of FIG. 2;

FIG. 4 is an exploded side view of embodiment of the speaker system of the present invention in a down firing configuration; and

FIG. 5 is a cross section view of a corner portion of the speaker system of the present invention illustrating an exemplary attachment of a grill and stand.

### DETAILED DESCRIPTION

The detailed embodiment of the present invention is described herein. It should be understood, however, that the disclosed embodiment is merely exemplary and that the invention may be embodied in a variety of forms. Therefore, the illustrated drawing figures and description herein should not be construed to limit or otherwise set forth the scope of the invention but rather to provide a basis for the claims and to teach the making of the present invention.

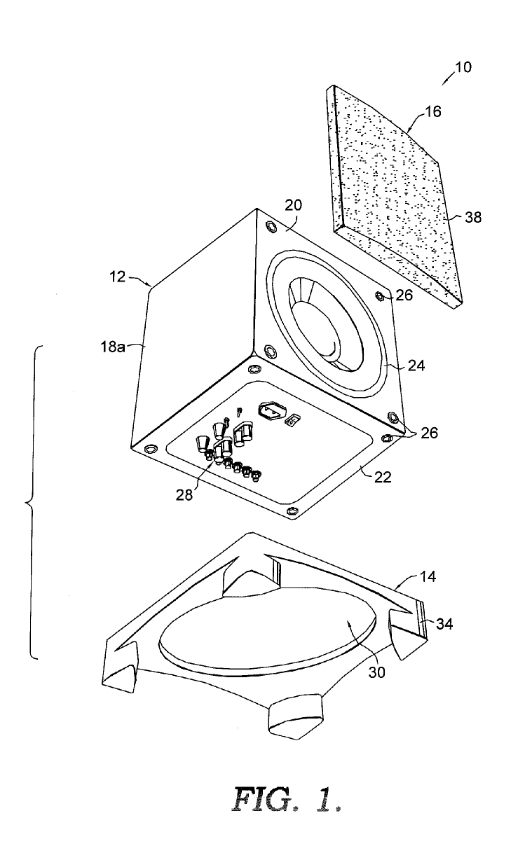

With reference to FIGS. 1-5, a subwoofer assembly 10 in accordance with the present invention is disclosed. The subwoofer assembly 10 includes a speaker enclosure 12 shaped and dimensioned to fit a stand 14 and includes a grill 16. The speaker enclosure 12 houses one or more acoustic sound source. Specifically, and as shown in an exploded view of an exemplary speaker system in FIG. 1, the speaker enclosure 12 includes a number of rigid side walls 18a, b, c, and d, a cone wall 20, and a connector wall 22. The cone wall 20 is connected by a first and second side wall 18a, 18b, a top wall 18c, a back wall 18d and the connector wall 20. In the preferred embodiment of the present invention, the sidewalls 18, cone wall 20 and connector wall 22 are approximately equally dimensioned, to form a cube like speaker enclosure 12. While the present invention calls for the speaker enclosure 12 to be cubic in shape, it is contemplated that certain sides thereof may be rectangular or polygonal depending on the corresponding stand (described later) to accommodate enclosure 12. The speaker enclosure 12 is preferably made of light weight materials in a variety of colors which are traditionally found in audio-visual equipment, although other materials may be employed without departing from the spirit of the invention.

The cone wall 20 includes a speaker cone 24 and a plurality of rubber or elastomeric grommets 26. The speaker cone 24 is recessed into the cavity of the speaker enclosure 12, as are the grommets 26. In the preferred embodiment of the present invention, the grommets 26 are located close to each corner of the cone wall 20; however, recessed areas could be formed in the same locations without the grommets.

The connector wall 22 has a number of electrical connectors 28 mounted on its surface. The connectors 28 provide for the connection of signal wires (not shown) to internal wiring of the speaker. The connector wall 22 also includes a plurality of rubber grommets 26, which are also located approximately in the corners of the connector wall 22.

The stand 14 provides a horizontal supporting surface for the speaker enclosure 12. The stand 14 includes an aperture 30, a stand surface 32, legs 34 and stand bosses 36 (see FIGS. 3, 4, and 5). As will be discussed in detail later in this document, the aperture 30 serves two functions with respect to the subwoofer assembly 10 of the present invention. Generally, the speaker enclosure 12 is oriented in a first configuration wherein the cone wall 20 contacts and rests upon the stand surface 32. In a second configuration, the connector wall 22 contacts and rests upon the stand surface 32. The legs 34 of the stand 14 elevate the speaker enclosure 12 off the floor or other supporting surface. The legs 34 are dimensioned to provide proper sound emanation for the speaker assembly 10 of the present invention when the speaker enclosure 12 is appropriately oriented with the cone wall 20 facing downward. The bosses 36 provide a mechanism by which the stand 14 may be attached to the speaker enclosure 12. However, it is within the scope of the invention that the speaker enclosure 12 need not be attached to the stand 14.

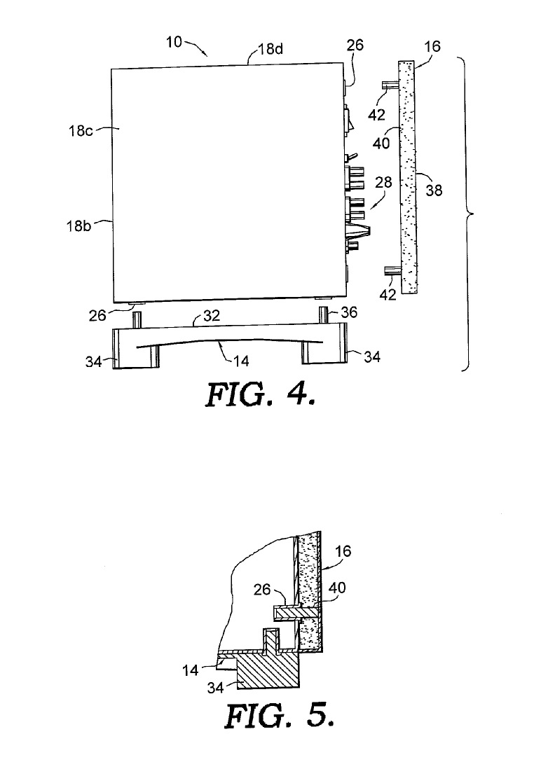

The grill 16 provides an aesthetic covering for portions of the speaker enclosure 12. The grill 16 includes a front material side 38, a rear contact side 40, and a plurality of grill bosses 42 (see FIGS. 3 and 4). In operation, the grill 16 is preferably attached to the speaker enclosure 12, with the front material side 38 facing outwardly and the rear contact side 40 facing inwardly towards the speaker enclosure 12. Attachment of the grill 16 is preferably by introducing the plurality of grill bosses 42 into the grommets 26 on either of the cone wall 20 or the connector wall 22.

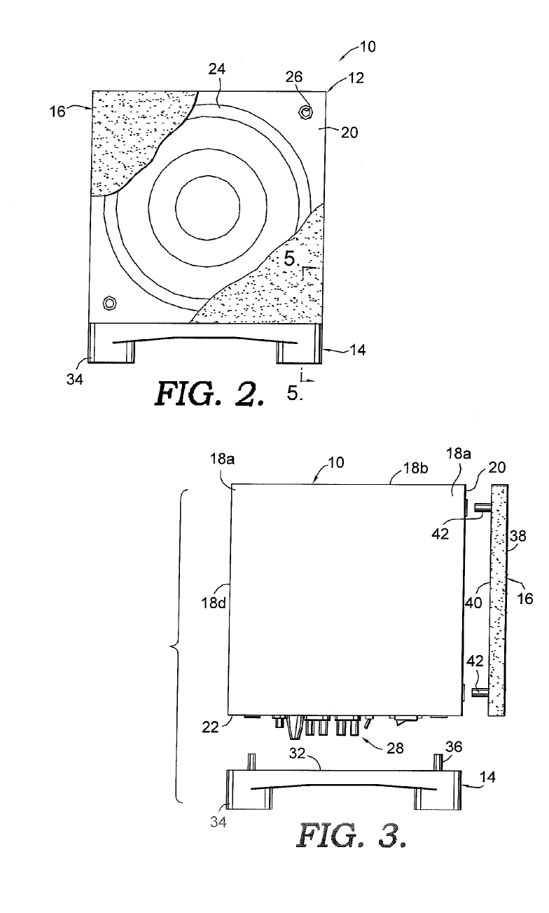

A perspective view of the subwoofer assembly 10 of the present invention is illustrated in FIG. 2. This figure depicts the speaker enclosure 12 in the front firing position. As shown, the speaker enclosure 12 is mounted on the stand 14. The grommets 26 located on the connector wall 22 receive the stand bosses 36. The grommets 26 and stand bosses 26 are well known in the art and are dimensioned to create a snug fit when engaged, so as to secure the stand 14 to the speaker enclosure 12. Similarly, the grill bosses 42 are also dimensioned to snuggly fit the grommets 26. The grill 16 is removedly attached to the cone wall 20. In this orientation, the grill bosses 42 engage the grommets 26 located on the cone wall 20. The alignment of the stand 14 and grill 16 with the speaker enclosure 12, along with one orientation of the speaker enclosure 12 is further illustrated in FIG. 3.

FIG. 3 is a partially exploded side view of the speaker assembly 10 illustrating the relative positions of the grill 16, stand 14, and connectors 28. In this orientation of the speaker assembly 10, i.e. a front or forward firing position which is known in the art, the cone wall 20 faces the selected direction or other environment where a listener may be located. Thus the terms front or forward are directional terms relative to the speaker's location on the stand and not necessarily relating to the speaker assembly's location in a room or space. Notably, in the present invention, the connectors 28 on the connector wall 22 are positioned within the circumference of the aperture 30 of the stand 14, thus enabling the speaker enclosure 12 to rest squarely onto the stand 14. Further, the stand bosses 36 hold the speaker enclosure 12 in position. Even further, the elevation provided by the stand 14 prevents the connectors 28 from resting directly upon the surface on which the speaker assembly 10 is located and provides a clearance for signal wires to be connected.

An alternative orientation and configuration for the speaker enclosure 12, stand 14 and grill 16 is illustrated in FIG. 4. In FIG. 4, an exploded side view of an embodiment of the speaker assembly 10 of the present invention in a down firing configuration is shown. In this embodiment, the down firing orientation is an alternative from the front firing orientation of FIG. 3 and is achieved by detaching the stand 14 and grill 16 from the speaker enclosure 12. The speaker enclosure 12 is then rotated ninety degrees in order to have the speaker cone 24 facing the floor or other supporting surface. In this orientation of the speaker assembly 10, i.e. a down firing position, the cone wall 20 faces the surface on which the speaker assembly 10 is resting. The connector wall 22 is directed into a room or other environment where a listener may be located. Notably, the elevation provided by the stand 14 enables proper sound emanation for the speaker assembly 10. The speaker cone 24 is positioned within the circumference of the aperture 30 of the stand 14, thus further enabling proper acoustic delivery. The speaker enclosure 12 rests squarely on the stand 14, on its cone wall 20. Further, the stand bosses 36 hold the speaker enclosure 12 in position by engaging the grommets 26 of the cone wall 20. If desired, the grill 16 can be attached to the connector wall 22 to obscure the electrical connectors 28 and present a more aesthetically pleasing appearance of the subwoofer assembly 10.

An important feature of the present invention that enables the functional versatility provided by the ability to rotate and utilize the speaker enclosure 12 of the present invention in a front firing or down firing configuration, is the interchangeable placement of the different walls 20,22 of the speaker enclosure 12 upon stand 14. The aesthetic versatility is achieved by a similar interchangeable placement of the grill 16.

FIG. 5 depicts a cross sectional view of a corner portion of the speaker system of the present invention illustrating an exemplary attachment of the grill 16 and stand 14, to the speaker enclosure 12. As shown, the matching placement of the grommets 26 on each of the cone wall 20 and connector wall 22, along with a corresponding matching placement of the stand bosses 36 and grill bosses 42 enable either of the stand 14 or grill 16 to be attached to either of the walls 20, 22 of the speaker enclosure 12. When either the stand 14 or grill 16 is attached to the speaker enclosure 12, the grummet 26 snuggly secures the corresponding boss 36, 42. Also as shown in FIG. 5, the perimeter surface of each of the stand 14 and grill 16 essentially line up with the corresponding surfaces of the speaker enclosure 12. It would be understood by one skilled in the art that the illustrated grommets 26 or bosses 36, 42 for attaching the components of subwoofer assembly 10 are merely exemplary and that other methods for attaching or placing such components, are contemplated and within the scope of the present invention.

The constructions described above and illustrated in the drawings are presented by way of example only and are not intended to limit the concepts and principles of the present invention. As such, it will be appreciated by one having ordinary skill in the art that various changes in the elements and their configuration and arrangement are possible without departing from the spirit and scope of the present invention as set forth in the claims.

What is claimed is:

1. The combination of a speaker enclosure and a stand, said combination including said enclosure having a plurality of walls, a driveable speaker located on one of said walls, said stand and said enclosure being cooperatively sized and configured to facilitate the interchangeable location of said walls of said enclosure upon said stand so that said speaker is alternatively in either a forward firing position or a down firing position.

2. The combination as in claim 1 wherein said stand has an enclosure supporting surface defining an opening therein to facilitate sound emanation when said enclosure is located on said stand in said down firing position.

3. The combination as in claim 2 wherein said opening and said speaker in said wall each have a circumference and wherein the circumference of said speaker is substantially located above the circumference of said opening in said down firing position.

4. The combination as in claim 3 wherein, one or more electrical connectors are located on a second one of said walls of said enclosure.

5. The combination as in claim 4, wherein said first and said second walls are perpendicular to each other and wherein said enclosure is rotatable approximately 90 degrees between said front firing position and said down firing position.

6. The combination as in claim 5 wherein, said enclosure is a cube.

7. The combination as in claim 4 further comprising a grill, wherein said grill may be attached to the available one of said first or second wall of said enclosure.

8. The combination as in claim 2 wherein, said stand elevates said enclosure to a height that is computed as a function of characteristics of said driveable speaker including the dimension of said driveable speaker.

9. A speaker apparatus, comprising:
a speaker enclosure having a driveable speaker located on a first side of said speaker enclosure, said first side having one or more recesses therein, a second side of said speaker enclosure having one or more recesses therein; and a stand having one or more bosses located so as to engage said one or more recesses of said first or second side of said enclosure when said driveable speaker is oriented in either of a front firing position or a down firing position.

10. A speaker apparatus as in claim 9, further comprising a grill having one or more bosses to engage said one or more recesses of said first or said second side of said speaker enclosure.

11. A speaker apparatus as in claim 10 wherein said grill and said stand are interchangeably attached to said first and second sides of said speaker enclosure when orienting said speaker apparatus between said forward firing position and said down firing position.

12. A speaker apparatus as in claim 9 wherein said speaker enclosure is a cube and said grill and said stand have a perimeter that is square and dimensioned to evenly match the perimeter of said cube.

13. A speaker apparatus as in claim 9 wherein said stand has an opening defined therein, said opening facilitating sound emanation when said driveable speaker is oriented in said down firing position.

14. A speaker apparatus as in claim 13 wherein said stand elevates said speaker enclosure to a height that is a function of said driveable speaker's dimensions.

15. A speaker apparatus including an enclosure having an acoustic sound source and means for alternatively locating said acoustic sound source in either a forward firing position or a down firing position.
